(19) United States
(12) Patent Application Publication
(10) Pub. No.: US 2017/0177204 A1
(43) Pub. Date: Jun. 22, 2017

(54) CENTERING GESTURE TO ENHANCE PINCH-TO-ZOOM GESTURE ON TOUCHSCREENS

(71) Applicant: Lenovo Enterprise Solutions (Singapore) PTE. LTD., New Tech Park (SG)

(72) Inventors: Paul Daniel Kangas, Raleigh, NC (US); Daniel Miles Ranck, Apex, NC (US)

(21) Appl. No.: 14/974,868

(22) Filed: Dec. 18, 2015

(51) Int. Cl. G06F 3/0488; G06F 3/0484

(52) U.S. Cl. CPC G06F 3/04883; G06F 3/04845; G06F 2203/04806; G06F 2203/04808

(57) ABSTRACT

A computing device detects movement of two contact positions on a touchscreen of the computing device as a pinch-to-zoom gesture. While detecting the movement of the two contact positions on the touchscreen, the computing device detects a third stationary contact position on the touchscreen of the computing device, as a centering gesture related to the pinch-to-zoom gesture. The computing device performs a zooming operation corresponding to the pinch-to-zoom gesture in relation to an image displayed on the touchscreen so that the image remains centered at the third stationary contact position corresponding to the centering gesture while the zooming operation is performed.

### BACKGROUND

Many types of modern computing devices employ touchscreens. Users, for example, can choose among smartphones, tablet computing devices, as well as laptop and desktop computers that have touchscreens. A touchscreen is a hardware display that includes a mechanism by which where the user touches the screen is detectable. Users can thus effectively manipulate graphical images and perform other actions by touching the screen.

### SUMMARY

An example method includes detecting, by a computing device, movement of two contact positions on a touchscreen of the computing device as a pinch-to-zoom gesture. The method includes, while detecting the movement of the two contact positions on the touchscreen, detecting, by the computing device, a third stationary contact position on the touchscreen of the computing device, as a centering gesture related to the pinch-to-zoom gesture. The method includes performing, by the computing device, a zooming operation corresponding to the pinch-to-zoom gesture in relation to an image displayed on the touchscreen so that the image remains centered at the third stationary contact position corresponding to the centering gesture while the zooming operation is performed.

An example non-transitory computer-readable data storage medium stores computer-executable code executable by a processor of a computing device including a touchscreen to perform a method. The method includes detecting movement of two contact positions on the touchscreen as a pinch-to-zoom gesture. The method includes, while detecting the movement of the two contact positions on the touchscreen, detecting a third stationary contact position on the touchscreen, as a centering gesture related to the pinch-to-zoom gesture. The method includes performing a zooming operation corresponding to the pinch-to-zoom gesture in relation to an image displayed on the touchscreen so that the image remains centered at the third stationary contact position corresponding to the centering gesture while the zooming operation is performed.

An example computing device includes a touchscreen, a processor, and a non-transitory computer-readable data storage medium storing computer-executable code. The processor executes the code to detect movement of two contact positions on the touchscreen as a pinch-to-zoom gesture. The processor executes the code to, while detecting the movement of the two contact positions on the touchscreen, detect a third stationary contact position on the touchscreen, as a centering gesture related to the pinch-to-zoom gesture. The processor executes the code to perform a zooming operation corresponding to the pinch-to-zoom gesture in relation to an image displayed on the touchscreen so that the image remains centered at the third stationary contact position corresponding to the centering gesture while the zooming operation is performed.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIGS. 1A and 1B are diagrams depicting a first example performance of a pinch-to-zoom gesture enhanced with a centering gesture.

FIGS. 2A and 2B are diagrams depicting a second example performance of a pinch-to-zoom gesture enhanced with a centering gesture.

FIG. 3 is a flowchart of an example method for performing a zooming operation corresponding to a pinch-to-zoom gesture that has been enhanced with a centering gesture.

FIG. 4 is a diagram of an example computing device including a touchscreen on which a pinch-to-zoom gesture that is enhanced with a centering gesture can be performed.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, many computing devices include touchscreens. As touchscreens have increased in popularity, gestures to manipulate images and perform other actions by a user touching a touchscreen have become commonplace. One such gesture is a pinch-to-zoom gesture.

In a pinch-to-zoom gesture, a user touches a touchscreen at two different positions using two digits of his or her hand. The user then moves the digits towards one another to zoom out the image being displayed on the touchscreen, so that more of the image is shown on the screen. The user can instead move the digits away from one another to zoom in the image being displayed on the touchscreen, so that less of the image is shown on the screen, but so that, for instance, more detail of the portion that is shown on the screen is displayed.

A disadvantage with the pinch-to-zoom gesture is that the image being zoomed in or zoomed out often does not stay centered on the touchscreen while the zooming operation occurs as the user engages in the pinch-to-zoom gesture. Alternatively, even if the image does stay centered on the touchscreen during the zooming operation, the user may have desired a different portion of the image being centered on the touchscreen. In either situation, the user therefore has to perform another gesture after completing the pinch-to-zoom gesture, such as a panning gesture in which the user presses and holds a digit against the touchscreen and moves the digit to cause corresponding movement of the image displayed on the screen.

Techniques disclosed herein provide an enhanced pinch-to-zoom gesture on a touchscreen via a centering gesture. The user touches a touchscreen at two different positions using two digits of his or her hand, such as a middle finger and a thumb, and performs movement of the digits towards or away from one another in a linear motion to effect the pinch-to-zoom gesture. At the same time, the user touches a touchscreen at a third position using a third digit of his or her hand, such as an index finger. The touching of the touchscreen at the third position using the third digit is a centering gesture related to the pinch-to-zoom gesture. A zooming operation is performed in relation to the image in correspondence with the pinch-to-zoom gesture in such a way that the image remains centered at the third position corresponding to the centering gesture.

In one implementation, the user may maintain the third digit on the touchscreen continually while performing the pinch-to-zoom gesture. In another implementation, the user may temporarily place the third digit on the touchscreen while performing the pinch-to-zoom gesture, such as by tapping the touchscreen. The techniques disclosed herein therefore provide users with an innovative manner by which to specify the location at which an image should be or remain centered while zooming in or out of the image, without having to perform a separate gesture after the user has completed the pinch-to-zoom gesture.

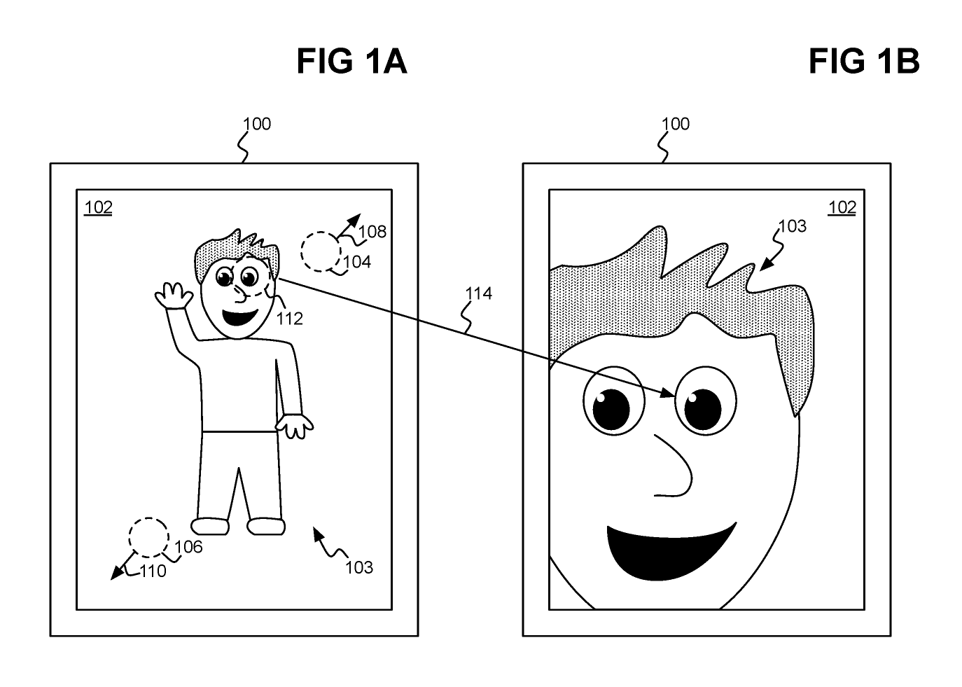

FIGS. 1A and 1B illustratively depict example performance of a pinch-to-zoom gesture that is enhanced with a centering gesture. A computing device 100 includes a touchscreen 102 on which an image 103 of a person is being displayed. In FIG. 1A, a user has touched the touchscreen 102 at three positions 104, 106, and 112, which are referred to as contact positions 104, 106, and 112. For example, the user may have made contact with the touchscreen 102 at the positions 104 and 106 with the middle finger and the thumb of his or her right hand, and may have made contact at the position 112 with the index finger of this same hand.

While still maintaining contact with the touchscreen 102 at least at the positions 104 and 106, the user moves the digits contacting the positions 104 and 106 away from one another in a linear motion, as indicated by the arrows 108 and 110. As such, the user is performing a pinch-to-zoom gesture via two digits of the user's hand making contact at the contact positions 104 and 106, specifically a zooming-in pinch-to-zoom gesture. While performing this gesture, the user makes contact with the touchscreen 102 at the contact position 112, either temporarily via a tap of the touchscreen 102, or continually while performing the pinch-to-zoom gesture. The user making contact at the contact position 112 with a third digit of his or her hand is a centering gesture related to the pinch-to-zoom gesture.

The contact position 112 denotes the part of the image 103 that is to remain centered while the image 103 is zoomed in. The contact position 112 in the example of FIG. 1A is on the left eye of the person in the image 103. The result of the zooming-in operation of FIG. 1A is depicted in FIG. 1B. As indicated by the arrow 114, the portion of the image under the contact position 112 at which the user made contact (i.e., the centering gesture) while performing the pinch-to-zoom gesture is centered in the zoomed-in image 103 on the touchscreen 102 of the computing device 100 in FIG. 1B.

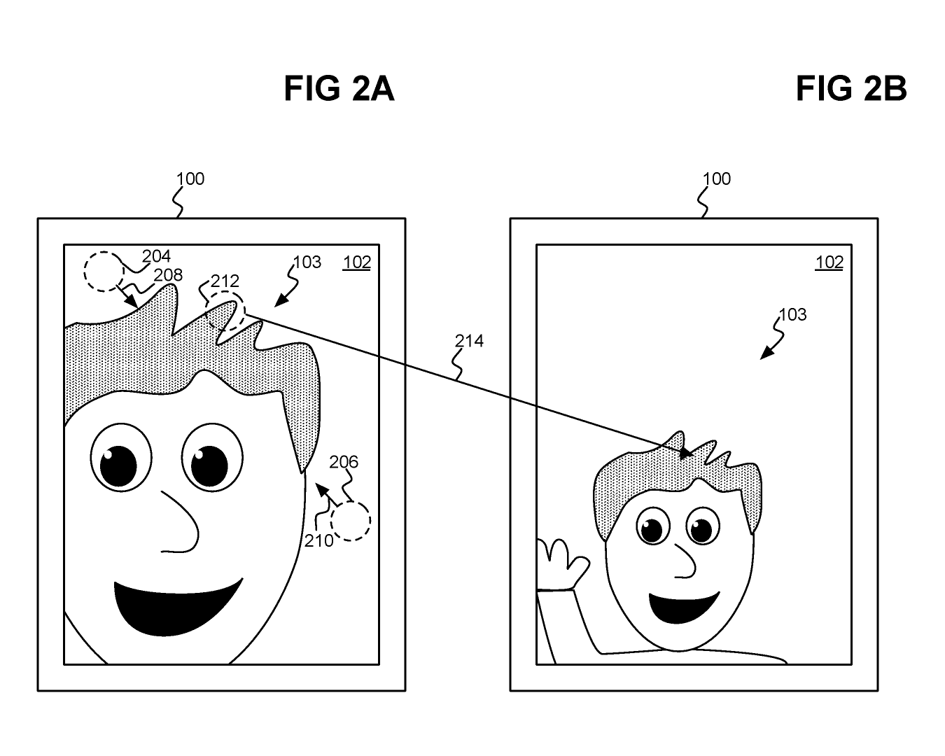

FIGS. 2A and 2B illustratively depict another example performance of a pinch-to-zoom gesture that is enhanced with a centering gesture. The computing device 100 includes the touchscreen 102 on which the image 103 of a person is being displayed. In FIG. 2A, a user has touched the touchscreen at three positions 204, 206, and 212, which are referred to as contact positions 204, 206, and 212. For example, the user may have made contact with the touchscreen 102 at the positions 204 and 206 with the middle finger and the thumb of his or her left hand, and may have made contact at the position 212 with the index finger of this same hand.

While still maintaining contact with the touchscreen at least at the positions 204 and 206, the user moves the digits contacting the positions 204 and 206 towards one another in a linear motion, as indicated by the arrows 208 and 210. As such, the user is performing a pinch-to-zoom gesture via two digits of the user's hand making contact at the contact positions 204 and 206, specifically a zooming-out pinch-to-zoom gesture. While performing this gesture, the user makes contact with the touchscreen 102 at the contact position 212, either temporarily via a tap of the touchscreen 102, or continually while performing the pinch-to-zoom gesture. The user making contact at the contact position 212 with a third digit of his or her hand is a centering gesture related to the pinch-to-zoom gesture.

The contact position 212 denotes the part of the image 103 that is to remain centered while the image 103 is zoomed out. The contact position 212 in the example of FIG. 2A is on a middle hair extending from the person's head in the image 103. The result of the zooming-out operation of FIG. 2A is depicted in FIG. 2B. As indicated by the arrow 214, the portion of the image under the contact position 212 at which the user made contact (i.e., the centering gesture) while performing the pinch-to-zoom gesture is centered in the zoomed-out image 103 on the touchscreen 102 of the computing device 100 in FIG. 2B.

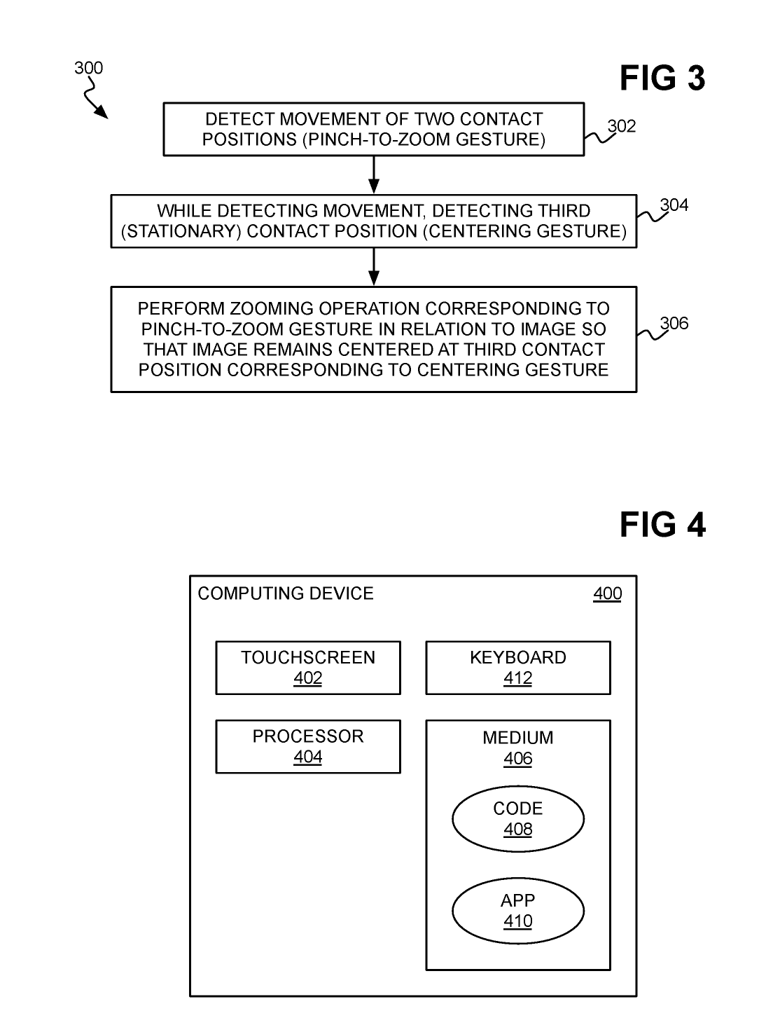

FIG. 3 shows an example method 300 for performing a zooming operation corresponding to a pinch-to-zoom gesture enhanced with a centering gesture. The method 300 is performed by a computing device having a touchscreen. The computing device detects movement of two contact positions on the touchscreen (302), as a pinch-to-zoom gesture. The two contact positions are positions at which contact has been made on the touchscreen, such as by two digits of a user's hand (e.g., a middle finger and a thumb). The movement that is detected may be towards one another in a linear motion, or away from one another in a linear motion. The former corresponds to a zooming out gesture, whereas the latter corresponds to a zooming in gesture.

While detecting movement of the two contact positions, the computing device further detects a third, stationary contact position on the touchscreen (304), as a centering gesture related to the pinch-to-zoom gesture. The third contact position is a third position at which contact has been made on the touchscreen, via another (third) digit of the user's hand (e.g., an index finger). In one implementation, the third contact position may be detected continually while the movement of the two contact positions is occurring. In another implementation, the third contact position may be detected as a temporary tap that occurs while the movement of the two contact positions is occurring. The third contact position is stationary in that it does not and is not moved on the touchscreen, as opposed to the other two contact positions that are in movement on the touchscreen.

The computing device performs a zooming operation corresponding to the pinch-to-zoom gesture in relation to an image displayed on the touchscreen, so that and such that the image remains or is centered at the third contact position corresponding to the zooming gesture, while the zooming operation is performed (306). For instance, if the pinch-to-zoom gesture is a zooming out gesture, the zooming operation that is performed is a zooming out operation in relation to the image displayed on the touchscreen, where the image is centered at the third contact position. As another example, if the pinch-to-zoom gesture is a zooming in gesture, the zooming operation that is performed is a zooming in operation in relation to the image displayed on the touchscreen, where the image is again centered at the third contact position.

FIG. 4 shows an example computing device 400 including a touchscreen 402 on which a pinch-to-zoom gesture that is enhanced with a centering gesture can be performed. The computing device 400 may be a mobile computing device, a smartphone, a tablet computing device, and/or a desktop or laptop computer, for instance. Besides the touchscreen 402, the computing device 400 includes a processor 404 and a non-transitory computer-readable data storage medium 406, and may also include a physical keyboard 412, particularly in the case in which the computing device 400 is a desktop or a laptop computer. The computing device 400 can and typically does include other hardware components, in addition to or in lieu of the touchscreen 402, the processor 404, the computer-readable medium 406, and the keyboard 412.

The computer-readable medium 406 may be volatile random-access memory or a non-volatile medium, such as non-volatile semiconductor memory or a hard disk drive. The medium 406 stores computer-execute code 408 and an application program 410 that the processor 404 executes or runs. The processor 404 executes the code 408 to perform the method 300 that has been described. The application program 410, when running on the computing device 400, displays an image that is the subject of the zooming operation that is performed as a result of the pinch-to-zoom gesture enhanced with a centering gesture being detected on the touchscreen 402. The application program 410, for instance, can be a mapping application program that displays a map image, an imaging application program like a picture-editing or viewing program that displays an image, and so on.

The techniques that have been disclosed herein thus permit users to more precisely perform zooming operations via a pinch-to-zoom gesture. Specifically, the pinch-to-zoom gesture is enhanced with a centering gesture. Via the centering gesture, users can specify where an image is to remain centered while performing the pinch-to-zoom gesture. Users can therefore zoom and center an image as desired at one time, instead of having to first zoom the image via one gesture and after completing that gesture then centering the image via another gesture.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Examples of non-transitory computer-readable media include both volatile such media, like volatile semiconductor memories, as well as non-volatile such media, like non-volatile semiconductor memories and magnetic storage devices. It is manifestly intended that this invention be limited only by the claims and equivalents thereof.

We claim:

1. A method comprising:
detecting, by a computing device, movement of two contact positions on a touchscreen of the computing device as a pinch-to-zoom gesture;
while detecting the movement of the two contact positions on the touchscreen, detecting, by the computing device, a third stationary contact position on the touchscreen of the computing device, as a centering gesture related to the pinch-to-zoom gesture; and
performing, by the computing device, a zooming operation corresponding to the pinch-to-zoom gesture in relation to an image displayed on the touchscreen so that the image remains centered at the third stationary contact position corresponding to the centering gesture while the zooming operation is performed.

2. The method of claim 1, wherein detecting the third stationary contact position on the touchscreen comprises:
detecting the third stationary contact position on the touchscreen continually while the movement of the two contact positions is occurring as the pinch-to-zoom gesture.

3. The method of claim 1, wherein detecting the third stationary contact position on the touchscreen comprises:
detecting the third stationary contact position on the touchscreen as a temporary tap while the movement of the two contact positions is occurring as the pinch-to-zoom gesture.

4. The method of claim 1, wherein detecting movement of the two contact positions on the touchscreen as the pinch-to-zoom gesture comprises:
detecting movement of the two contact positions towards one another in a linear motion, the pinch-to-zoom gesture being a zooming out gesture,
and wherein performing the zooming operation corresponding to the pinch-to-zoom gesture so that the image remains centered at the third stationary contact position corresponding to the centering gesture comprises:
performing a zooming out operation in relation to the image displayed on the touch screen while maintaining the image centered at the third stationary contact position.

5. The method of claim 1, wherein detecting movement of the two contact positions on the touchscreen as the pinch-to-zoom gesture comprises:
detecting movement of the two contact positions away from one another in a linear motion, the pinch-to-zoom gesture being a zooming in gesture,
and wherein performing the zooming operation corresponding to the pinch-to-zoom gesture so that the image remains centered at the third stationary contact position corresponding to the centering gesture comprises:
performing a zooming in operation in relation to the image displayed on the touch screen while maintaining the image centered at the third stationary contact position.

6. The method of claim 1, wherein the two contact positions detected on the touchscreen result from a user making contact with the touchscreen at the two contact positions via two digits of a hand of the user,
and wherein the third stationary contact position detected on the touchscreen results from the user making contact with the touchscreen at the third stationary contact position via a third digit of the hand of the user.

7. The method of claim 6, wherein the two digits of the hand of the user comprises a middle finger and a thumb of the hand of the user,
and wherein the third digit of the hand of the user comprises an index finger of the hand of the user.

8. A non-transitory computer-readable data storage medium storing computer-executable code executable by a processor of a computing device including a touchscreen to perform a method comprising:
detecting movement of two contact positions on the touchscreen as a pinch-to-zoom gesture;
while detecting the movement of the two contact positions on the touchscreen, detecting a third stationary contact position on the touchscreen, as a centering gesture related to the pinch-to-zoom gesture; and
performing a zooming operation corresponding to the pinch-to-zoom gesture in relation to an image displayed on the touchscreen so that the image remains centered at the third stationary contact position corresponding to the centering gesture while the zooming operation is performed.

9. The non-transitory computer-readable data storage medium of claim 8, wherein detecting the third stationary contact position on the touchscreen comprises:
detecting the third stationary contact position on the touchscreen continually while the movement of the two contact positions is occurring as the pinch-to-zoom gesture.

10. The non-transitory computer-readable data storage medium of claim 8, wherein detecting the third stationary contact position on the touchscreen comprises:
detecting the third stationary contact position on the touchscreen as a temporary tap while the movement of the two contact positions is occurring as the pinch-to-zoom gesture.

11. The non-transitory computer-readable data storage medium of claim 8, wherein the image in relation to which the zooming operation corresponding to the pinch-to-zoom gesture is performed so that the image remains centered at the third stationary contact position corresponding to the centering gesture while the zooming operation is performed comprises:
a map image displayed by a mapping application program running on the computing device.

12. The non-transitory computer-readable data storage medium of claim 8, wherein the image in relation to which the zooming operation corresponding to the pinch-to-zoom gesture is performed so that the image remains centered at the third stationary contact position corresponding to the centering gesture while the zooming operation is performed comprises:
an image displayed by an imaging application program running on the computing device.

13. A computing device comprising:
a touchscreen;
a processor; and
a non-transitory computer-readable data storage medium storing computer-executable code that the processor executes to:
detect movement of two contact positions on the touchscreen as a pinch-to-zoom gesture;
while detecting the movement of the two contact positions on the touchscreen, detect a third stationary contact position on the touchscreen, as a centering gesture related to the pinch-to-zoom gesture; and
perform a zooming operation corresponding to the pinch-to-zoom gesture in relation to an image displayed on the touchscreen so that the image remains centered at the third stationary contact position corresponding to the centering gesture while the zooming operation is performed.

14. The computing device of claim 13, wherein the processor is to detect the third stationary contact position on the touchscreen by:
detecting the third stationary contact position on the touchscreen continually while the movement of the two contact positions is occurring as the pinch-to-zoom gesture.

15. The computing device of claim 13, wherein the processor is to detect the third stationary contact position on the touchscreen by:
detecting the third stationary contact position on the touchscreen as a temporary tap while the movement of the two contact positions is occurring as the pinch-to-zoom gesture.

16. The computing device of claim 13, wherein the computing device is a mobile computing device.

17. The computing device of claim 13, wherein the computing device is a tablet computing device.

18. The computing device of claim 13, wherein the computing device is a smartphone.

19. The computing device of claim 13, wherein the computing device is a desktop or laptop computer including a physical keyboard in addition to the touchscreen.
